(19) United States
(12) Patent Application Publication
(10) Pub. No.: US 2014/0352666 A1
(43) Pub. Date: Dec. 4, 2014

(54) COMMON RAIL INJECTOR HAVING SWIRL SPRAY NOZZLE

(71) Applicant: Doc Koon Yoo, Gyeonggi-do (KR)

(72) Inventor: Doc Koon Yoo, Gyeonggi-do (KR)

(21) Appl. No.: 14/367,085

(22) PCT Filed: Aug. 31, 2012
(86) PCT No.: PCT/KR2012/006992

§ 371 Date: Jun. 19, 2014

(30) Foreign Application Priority Data
Dec. 21, 2011 (KR) 10-2011-0139390

(51) Int. Cl. F02M 63/02

(52) U.S. Cl. CPC F02M 63/0275
USPC 123/456

(57) ABSTRACT

The present disclosure relates to a common rail injector having a swirl spray nozzle which has a tip having an orifice at a lower end portion of a housing. An upper portion of the tip is closed by means of a cup-shaped nozzle portion, the nozzle portion has a cylindrical side wall surface, a flat base which terminates an upper portion of the side wall surface, and one or more nozzle holes which allow the hollow portion and the orifice to communicate with each other, and the nozzle holes are formed in a tangential direction of the orifice so as to inject fuel in a swirl manner.

### CROSS-REFERENCE TO RELATED APPLICATION

This Application is a Section 371 National Stage Application of International Application No. PCT/KR2012/006992, filed Aug. 31, 2012 and published, not in English, as WO 2013/094845 on Jun. 27, 2013.

### FIELD OF THE DISCLOSURE

The present disclosure relates to a common rail injector, and more particularly, to a common rail injector which has a nozzle capable of injecting fuel into a combustion chamber in a swirl manner.

### BACKGROUND OF THE DISCLOSURE

In general, a common rail system is supplied with fuel from a common rail under the control of an engine control unit of a high-pressure pump, and has one or more injectors that may inject fuel into combustion chambers of an engine.

Particularly, in order to improve performance of the engine and fuel efficiency, the injector of the common rail system needs to more precisely control atomization and sizes of particles of fuel. The common rail injector is disclosed in Patent Literature 1.

As already known widely, a common rail injector disclosed in Patent Literature 1 includes a housing, a fuel line, a nozzle needle, and a nozzle.

The common rail injector according to the related art has an internal space that is provided in the housing so as to accommodate the nozzle needle. In addition, the nozzle needle may reciprocate in the internal space of the housing. Fuel supplied into the injector through a fuel supply line passes through the nozzle, which is positioned at a lower end portion of the housing and opened by an upward movement of the nozzle needle, and is injected into the combustion chamber.

The common rail injector having the aforementioned structure has a plurality of nozzles that is provided at the lower end portion of the housing. The plurality of nozzles is formed to penetrate the lower end portion of the housing in a radial direction so as to inject fuel into the combustion chamber at a high pressure in a straight spray manner.

In addition, the nozzle is formed at the lower end portion of the housing, and has a cross section in the form of a generally cylindrical straight tube or funnel. A diameter of the nozzle is varied in the form of a contracting tube so that the diameter is smaller as being closer to an outlet portion than an inlet portion of the nozzle.

Accordingly, the common rail injector in the related art is configured to facilitate atomization of fuel while accelerating fuel that passes through a cross section having a shape of a straight tube or a contracting tube.

The common rail injector sprays fuel in the straight spray manner as described above, and a part of fuel sprayed in the straight spray manner cannot sufficiently come into contact with intake air in the combustion chamber.

In addition, the fuel injection in the straight spray manner cannot accurately correspond to a shape of the combustion chamber, and because of characteristics of fuel that is injected at a high speed, fuel is not mixed with intake air that will flow into the combustion chamber, but collides with an inner wall of the combustion chamber.

Therefore, fuel is cooled while colliding with the inside of the combustion chamber, such that fuel is incompletely combusted, and as a result, soot is produced. In a case in which soot is attached to the inside of the combustion chamber, the soot will cause deterioration in performance of the engine.

In order to supplement the straight spray manner of fuel, Patent Literature 2 discloses a swirl spray injector for an internal combustion engine which may supply fuel to be injected in a swirl manner.

The injector of Patent Literature 2 has a swirl groove formed in an outer circumferential surface of a needle. In addition, in the injector, fuel to be supplied at a high pressure is moved along the swirl groove formed in the needle, and discharged into the combustion chamber after passing through a cylindrical discharge orifice. In this case, fuel flows as a swirl flow while passing through the swirl groove, and fuel, which will be injected through the cylindrical discharge orifice that is opened by an upward movement of the needle, causes a pressure drop phenomenon, such that fuel cannot be diffused widely into the combustion chamber.

In addition, the fuel, which will be injected along the swirl groove of the needle, is injected in the swirl manner even in a space between an end of the needle and the cylindrical discharge orifice, such that a significant collision may be expected at an inlet portion of the cylindrical discharge orifice, and the collision causes a problem in that an injection speed of fuel is decreased, and a degree of a swirl flow is reduced.

Therefore, in order to resolve the aforementioned problem, experts in the corresponding technical field seek other ways to promote diffusion of fuel in the combustion chamber and further reduce sizes of droplets of fuel.

### LITERATURE OF RELATED ART

### Patent Literature

Patent Literature 1: Korean Patent Application Laid-Open No. 10-2005-0070393

Patent Literature 2: U.S. Pat. No. 6,510,836

The discussion above is merely provided for general background information and is not intended to be used as an aid in determining the scope of the claimed subject matter.

### SUMMARY

This summary and the abstract are provided to introduce a selection of concepts in a simplified form that are further described below in the Detailed Description. The summary and the abstract are not intended to identify key features or essential features of the claimed subject matter, nor are they intended to be used as an aid in determining the scope of the claimed subject matter.

Therefore, a technical object to be achieved in the present disclosure is to provide a common rail injector which may widely diffuse fuel into a combustion chamber while minimizing a structural change of the injector.

A technical problem to be achieved in the present disclosure is not limited to the aforementioned technical problem, and any other not-mentioned technical problem will be obviously understood from the description below by those skilled in the technical field to which the present disclosure pertains.

In order to achieve the aforementioned object, a common rail injector having a swirl spray nozzle according to the present disclosure includes a hollow portion, a nozzle needle which reciprocates in the hollow portion in an upward and downward direction, and a tip having an orifice at a lower end portion thereof, and injects fuel into a combustion chamber.

Particularly, an upper portion of the tip of the present disclosure is closed by means of a cup-shaped nozzle portion, the nozzle portion has a cylindrical side wall surface, a flat base which terminates an upper portion of the side wall surface, and one or more nozzle holes which allow the hollow portion and the orifice to communicate with each other, and the nozzle holes are formed in a tangential direction of the orifice so as to inject fuel in a swirl manner.

In the present disclosure, the orifice may be formed to have a conical cross section having an expanding tube shape, a diameter of which is gradually increased from an upper side to a lower side.

In the present disclosure, the nozzle hole is drilled at an upper end of the side wall surface.

In particular, the nozzle holes of the present disclosure are arranged at equal intervals in a circumferential direction of the side wall surface, and assist in uniform injection of fuel.

In addition, in the present disclosure, the nozzle hole is disposed to be inclined downward toward the orifice. In addition, the nozzle hole is drilled up to the orifice from a tangential direction of the orifice to a radial direction on the basis of a central axis of the injector, that is, an angle at 90° with the tangential direction.

First of all, terms or words used in the specification and the claims should not be interpreted as a general and dictionary meaning and should be interpreted as a meaning and a concept which conform to the technical spirit of the present disclosure based on a principle that an inventor can appropriately define a concept of a term in order to describe his/her own disclosure by the best method.

According to the aforementioned description of the present disclosure, the present disclosure is provided to inject fuel into the combustion chamber in the swirl manner.

The present disclosure may improve combustion efficiency by efficiently mixing fuel and air in the combustion chamber using the injector that injects fuel in the swirl manner.

In addition, the present disclosure further reduces sizes of particles of fuel, which swirls at a high speed, so as to promote complete combustion in an engine.

### DESCRIPTION OF THE DRAWINGS

FIG. 1 is a schematic cross-sectional view of a common rail injector according to a first exemplary embodiment of the present disclosure.

FIG. 2 is an enlarged view of a circular arc portion illustrated in FIG. 1.

FIG. 3 is a cross-sectional view taken along line A-A of FIG. 2.

FIG. 4 is a partially enlarged view of a common rail injector according to a second exemplary embodiment of the present disclosure.

### DESCRIPTION OF MAIN REFERENCE NUMERALS OF DRAWINGS

1: Injector

10: Housing

11: Fuel line

12: Hollow portion

13: Nozzle needle

14: Tip

20: Nozzle portion

21: Side wall surface

22: Base

23: Nozzle hole

141: Orifice

### DETAILED DESCRIPTION

Advantages and features of the present disclosure and methods of achieving the advantages and features will be clear with reference to an exemplary embodiment described in detail below together with the accompanying drawings.

Like reference numerals indicate like elements throughout the specification, constituent elements identical to constitute elements in the related art will be indicated by the same reference numerals, and detailed descriptions thereof will be omitted.

A common rail injector having a swirl spray nozzle according to the present disclosure will be described in detail with reference to the accompanying drawings.

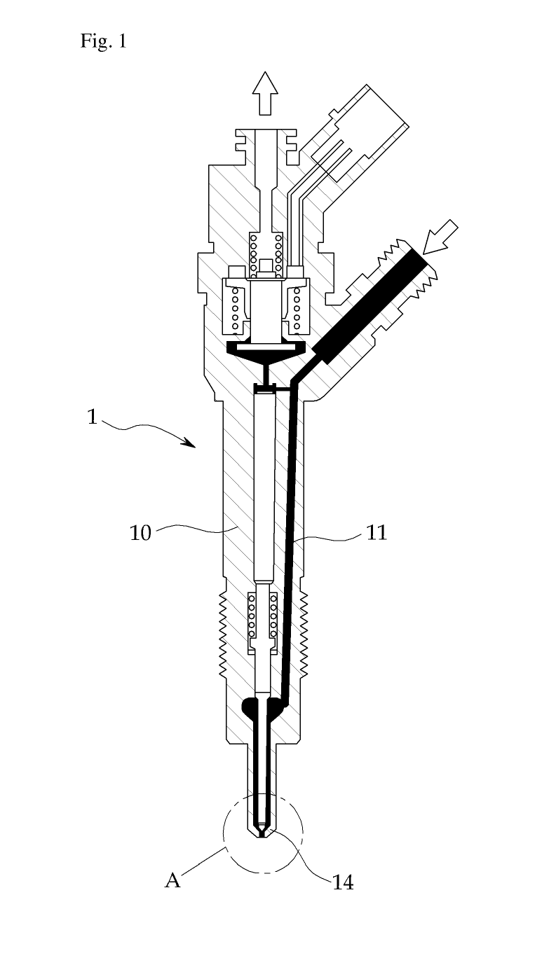

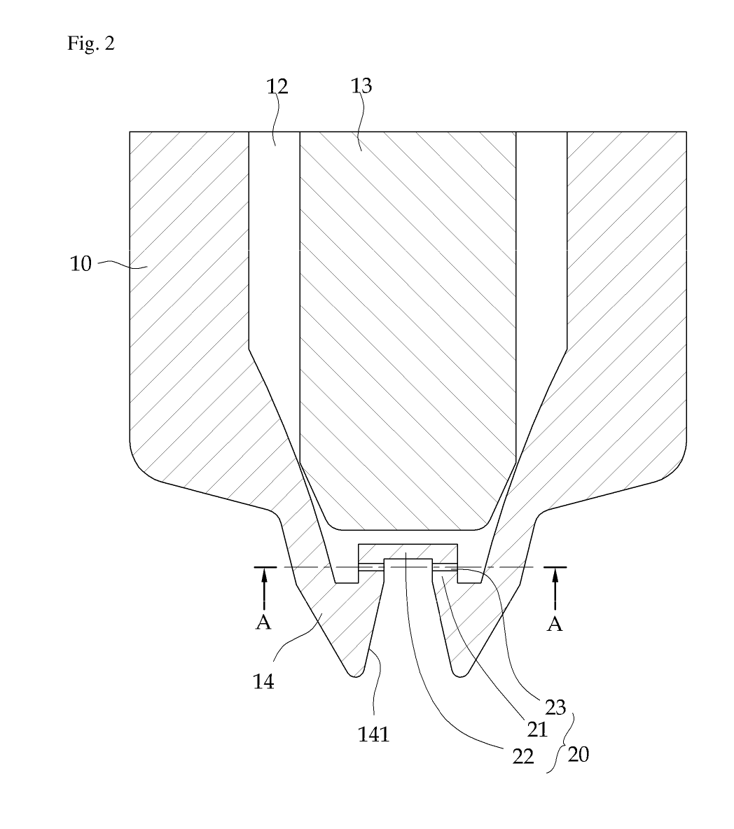

FIG. 1 is a schematic cross-sectional view of a common rail injector according to a first exemplary embodiment of the present disclosure, and FIG. 2 is an enlarged view of a circular arc portion A of FIG. 1.

The common rail injector 1 according to the first exemplary embodiment of the present disclosure includes a housing 10, and a nozzle provided at a lower end portion of the housing 10.

Specifically, the injector 1 of the present disclosure includes the housing 10, a fuel line 11, a hollow portion 12, a nozzle needle 13, and a nozzle portion 20.

Particularly, the injector 1 according to the present disclosure has the nozzle portion 20 that is provided at a free end portion that is disposed to protrude into a combustion chamber (not illustrated). The free end portion may also be typically called a tip 14 of the injector.

The housing 10 is formed in a hollow cylindrical shape, and has the nozzle portion 20 that is provided at the lower end portion of the housing 10, that is, at the tip 14. The housing 10 accommodates the nozzle needle 13 that is mounted in the hollow portion 12 so as to vertically reciprocate in an axial direction.

The fuel line 11 supplies fuel, which is supplied to a common rail along a fuel supply line, to the injector 1 according to the present disclosure.

As described herein, fuel, which is supplied into the housing 10 along the fuel line 11, is controlled to be supplied to the combustion chamber by opening or closing nozzle holes 23 in accordance with upward and downward movements of the nozzle needle 13.

The injector 1 may inject fuel, which flows into the fuel line 11 as described above, in a swirl manner into the combustion chamber by means of one or more nozzle holes 23 arranged at an upper portion of the nozzle portion 20.

Referring to FIG. 2, the nozzle portion 20 of the present disclosure is disposed while a center of the tip 14 is used as a concentric axis.

Particularly, a cylindrical orifice 141 is formed at a center of the tip 14, and an upper portion of the orifice 141 is terminated by the nozzle portion 20. Alternatively, the orifice 141 may provide a conical cross section having a diameter that is gradually increased from an upper side to a lower side thereof.

The orifice 141 having the conical cross section improves swirl injection of fuel so as to allow fuel to be efficiently mixed with air that flows in the combustion chamber in an air flow direction, for example, in the swirl manner.

In other words, fuel to be injected in the swirl manner and air flowing in the swirl manner may be optimally mixed so as to reduce exhaust gas such as soot.

As described above, the nozzle portion 20 is positioned at the lower end portion of the injector 1, and has the nozzle hole 23 that may ensure the injection of fuel. The nozzle portion 20 includes a cylindrical side wall surface 21, and a flat base 22.

The side wall surface 21 of the nozzle portion 20 is disposed at an upper end of the orifice 141, and an inner surface of the tip 14, which delimits the side wall surface 21 of the nozzle portion 20 and the orifice 141, may be integrally formed to improve durability.

The nozzle portion 20 is formed in a cup shape formed by closing an upper portion of the cylindrical side wall surface 21 using the flat base 22, and opening a lower portion.

In addition, the nozzle portion 20 has the nozzle hole 23 which is provided in the side wall surface 21 of the nozzle portion 20, through which fuel accommodated in the housing 10 may be injected to the outside at a high speed. The nozzle hole 23 is drilled at an upper end of the side wall surface 21, and may be positioned below the base 22.

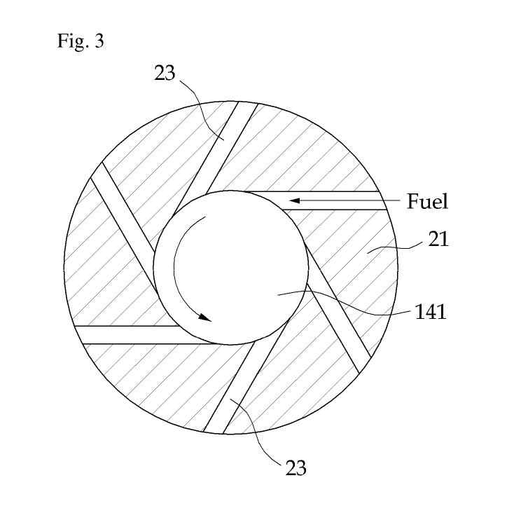

FIG. 3 is a cross-sectional view taken along line A-A of FIG. 2, and illustrates a state in which the flat base 22 of the nozzle portion 20 is excluded.

The nozzle hole 23 penetrates the side wall surface 21 of the nozzle portion 20 (see FIG. 2). In other words, the nozzle hole 23 allows the orifice 141 and the hollow portion 12 (see FIG. 1) of the housing to communicate with each other.

Unlike the related art, the nozzle hole 23 is not formed in a tube shape in a radial direction toward the outside from a central axis of the orifice 141, but is formed to penetrate the side wall surface 21 in a direction corresponding to a tangential direction of the orifice 141.

The aforementioned nozzle hole 23 formed in the tangential direction is opened by the upward movement of the nozzle needle 13 (see FIG. 2), and then, fuel flows into the orifice 141 along a flow path formed by the nozzle hole 23.

In this case, fuel flows in the tangential direction of the orifice 141, and as a result, fuel may be injected in the swirl manner while flowing along an inner circumferential surface of the orifice 141 of the tip. Arrows indicate flow directions of fuel.

Six nozzle holes 23 are drilled in the side wall surface 21 as illustrated in FIG. 3, but the present disclosure is not limited thereto, and the number of nozzle holes 23 drilled may be varied depending on a flow rate of fuel to be injected, and intensity of the swirl manner.

Alternatively, the nozzle holes 23 are arranged at equal intervals in a circumferential direction of the side wall surface 21. The configuration may uniformly diffuse fuel to be injected in the swirl manner into the combustion chamber.

Particularly, intensity of a swirl flow of fuel will be gradually decreased as an angle of the nozzle hole 23 is increased from the tangential direction to the radial direction of the orifice 141. Therefore, the incident angle of the nozzle hole 23 with respect to the orifice 141 may be varied in order to adjust intensity of a swirl flow of fuel in the nozzle hole 23. For example, the nozzle hole 23 may be drilled from the tangential direction of the orifice 141 to an angle of 90° (that is, the configuration means that the nozzle hole 23 is formed in a direction perpendicular to the tangential direction).

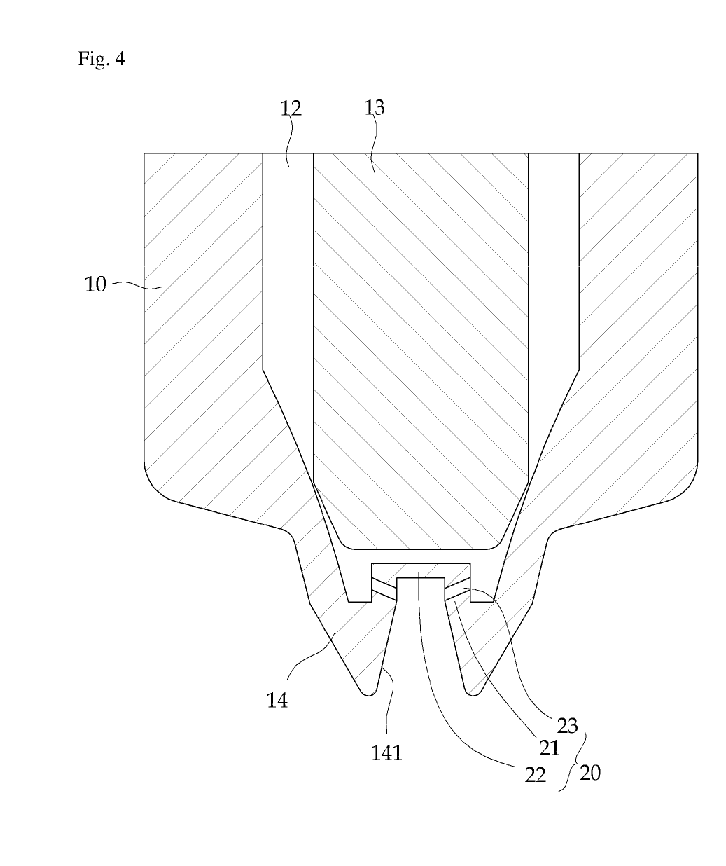

FIG. 4 is an enlarged view of a lower portion of a common rail injector according to a second exemplary embodiment of the present disclosure, and because the second exemplary embodiment has the same configuration as the first exemplary embodiment except for the common rail injector and the nozzle portion 20, a duplicated description will be omitted herein.

As illustrated, a nozzle portion 20 is positioned at a lower end portion of an injector, and includes a cylindrical side wall surface 21, a flat base 22, and nozzle holes 23 that provide flow paths of fuel.

Particularly, the nozzle portion 20 according to the second exemplary embodiment of the present disclosure has a nozzle hole 23 that is inclined downward. That is, the nozzle hole 23 is formed in a tube shape while penetrating the side wall surface 21, and inclined downward in an axial direction, that is, toward the orifice 141.

The inclined nozzle hole 23 may allow fuel to more easily flow into a combustion chamber, and may assist in a swirl action of the fuel that is injected downward.

The exemplary embodiments of the present disclosure have been described with reference to the accompanying drawings, but those skilled in the art will understand that the present disclosure may be implemented in any other specific form without changing the technical spirit or an essential feature thereof.

Accordingly, it will be understood that the aforementioned exemplary embodiments are described for illustration in all aspects and are not limited, and it will be construed that the scope of the present disclosure of the detailed description is represented by the claims to be described below, and all of the changes or modified forms induced from the meaning and the scope of the claims, and an equivalent concept thereof are included in the scope of the present disclosure.

The common rail injector having a swirl spray nozzle according to the present disclosure injects fuel in the swirl manner, and as a result, the common rail injection may be used in a common rail system that requires an improvement on combustion efficiency as well as a reduction in exhaust gas.

Although the present disclosure has been described with reference to exemplary and preferred embodiments, workers skilled in the art will recognize that changes may be made in form and detail without departing from the spirit and scope of the disclosure.

1. A common rail injector having a swirl spray nozzle which includes a housing including: a hollow portion; a nozzle needle which vertically reciprocates in the hollow portion; and a tip having an orifice at a lower end portion thereof, and injects fuel into a combustion chamber, the common rail injector comprising:
a cup-shaped nozzle portion which includes a cylindrical side wall surface, a flat base which terminates an upper portion of the side wall surface, and one or more nozzle holes which allow the hollow portion and the orifice to communicate with each other,
wherein the nozzle holes are formed in a tangential direction of the orifice, and an upper portion of the tip is closed by means of the nozzle portion.

2. The common rail injector of claim 1, wherein the orifice has a conical cross section having a diameter that is gradually increased from an upper side to a lower side of the orifice.

3. The common rail injector of claim 1, wherein the nozzle hole are drilled at an upper end of the side wall surface.

4. The common rail injector of claim 1, wherein the nozzle holes are arranged at equal intervals in a circumferential direction of the side wall surface.

5. The common rail injector of claim 1, wherein the fuel is sprayed in a swirl manner.

6. The common rail injector of claim 1, wherein the nozzle hole is inclined downward toward the orifice.

7. The common rail injector of claim 1, wherein the nozzle hole is formed between a tangential direction of the orifice and a direction perpendicular to the tangential direction.
